(19) United States
(12) Patent Application Publication
(10) Pub. No.: US 2026/0216664 A1
(43) Pub. Date: Jul. 30, 2026

(54) ANNULAR MEMBRANE ASSEMBLY FOR SELECTIVE CARBON CAPTURE

(71) Applicant: Valero Services, Inc., San Antonio, TX (US)

(72) Inventors: Michael A. Miller, Helotes, TX (US); Terrence F. Alger, II, San Antonio, TX (US); Barrett W. Mangold, Hondo, TX (US); Graham Thomas Conway, San Antonio, TX (US); Jason Daniel Herrera, San Antonio, TX (US)

(73) Assignee: Valero Services, Inc., San Antonio, TX (US)

(21) Appl. No.: 19/389,726

(22) Filed: Nov. 14, 2025

Related U.S. Application Data
(60) Provisional application No. 63/749,755, filed on Jan. 27, 2025.

(51) Int. Cl. B01D 71/02; B01D 53/22; B01D 63/06; B01D 67/00; B01D 69/04

(52) U.S. Cl. CPC B01D 71/024; B01D 53/22; B01D 63/061; B01D 63/063; B01D 67/0039; B01D 67/0083; B01D 67/0088; B01D 69/046; B01D 2053/223; B01D 2257/504; B01D 2323/42

(57) ABSTRACT

The present disclosure provides apparatus, methods, and systems for manufacturing membrane assemblies for selective carbon dioxide (CO₂) separation. The apparatus includes coaxially arranged perforated tubes defining an annular space containing a solid-state lithium zirconate membrane. The method includes steps for introducing and compressing membrane material within the annular space to form a dense, selective membrane structure. The system provides mechanical components for controlled formation of the membrane assembly. The disclosure enables practical implementation of solid-state CO₂ capture technology for industrial and vehicle emissions through a novel manufacturing approach that overcomes traditional limitations in processing ionic solid membranes.

### CROSS-REFERENCE TO RELATED APPLICATIONS

This application claims priority to U.S. Provisional Patent Application No. 63/749,755, filed January 27, 2025, the content of which is incorporated herein by reference in its entirety.

### FIELD

The present disclosure relates to durable membrane assemblies for selective separation of gas mixtures from high-temperature effluents. More particularly, the disclosure relates to methods and apparatus for manufacturing lithium zirconate-based membrane assemblies within an annular space confined by perforated tubes for selective separation of carbon dioxide from gas mixtures generated from the combustion of fossil fuels.

### BACKGROUND

Carbon dioxide (CO₂) capture and separation from industrial and vehicle emissions remains a critical challenge in addressing climate change. Conventional CO₂ capture technologies often rely on liquid absorbents or adsorbent materials, which can be energy-intensive and have limitations in terms of efficiency and scalability.

Ionic solids such as lithium zirconate (Li₂ZrO₃), also referred to as LZO, have been investigated for their potential use as a solid-state membrane in various applications, including the separation of carbon dioxide from gas mixtures, such as in carbon capture and storage and hydrogen production. LZO has shown promise as a solid-state membrane for CO₂ separation via capture and regeneration due to its high selectivity for CO₂. This selectivity arises from a chemisorption equilibrium reaction between CO₂ and LZO, yielding lithium carbonate (Li₂CO₃) and zirconate (ZrO₂) through a complex mechanism whereby CO₂ is incorporated into the crystal lattice of LZO, whereas other gas species are much less readily absorbed via physisorption.

Despite its potential advantages, there are material challenges associated with the practical implementation of LZO and similar ionic solids into industrial processes as selective membranes. These challenges include, for example, the manufacturability of mechanically robust membranes, long-term stability and durability of the material under cyclic thermal and sorption conditions, and the cost of manufacturing and maintaining such membranes.

A fundamental characteristic of any separation membrane is the measured selectivity for permeation of one chemical species versus a different one from a mixture of species. LZO and similar ionic solids theoretically achieve ideal chemical selectivity for CO₂ under thermally activated conditions through the chemisorption equilibrium reaction noted above. However, the selectivity actually realized is less than ideal because it is compounded by passive physisorption and permeation of other species, otherwise known as physical permeation, through the intergranular microstructure of the membrane.

In the processing of ceramic and metal powders through traditional methods, the porosity of an object derived from such powders can be minimized through isostatic (or uniaxial) compression and high temperature sintering of the powder compact, either separately or combined in one process. For example, hot isostatic pressing (HIP) is well known to those familiar with the art of ceramic powder and metal powder processing. Although HIP may be effective in reducing the porosity of many powder-derived objects, often achieving greater than 95% of theoretical density, the process equipment is costly and not amenable to processing all geometric shapes.

In the context of processing an ionic solid like LZO, minimizing the porosity of the formed object by traditional means is hampered by material properties that differ uniquely from most technical ceramics such as zirconia (ZrO₂) and alumina (Al₂O₃). The poor cohesion and limited sinterability of the powder, low fracture toughness of the formed object, and significant volumetric changes that occur during CO₂ sorption and thermal cycling, conspire to introduce residual porosity with a complementary decay in chemical selectivity.

Therefore, there exists a need for improved apparatus and methods for selective carbon capture.

### BRIEF SUMMARY

The present disclosure addresses this need by providing apparatus, methods, and systems for manufacturing membrane assemblies for selective CO₂ separation. The apparatus includes coaxially arranged perforated tubes defining an annular space containing a solid-state lithium zirconate membrane. The method includes steps for introducing and compressing membrane material within the annular space to form a dense, selective membrane structure. The system provides mechanical components for controlled formation of the membrane assembly.

Along a similar theme as above, a whole-body tubular membrane may be alternatively formed by compression molding the membrane material in a two-part mold. In yet a third method, a whole-body membrane may be formed by first over-wrapping previously rolled or tape casted membrane material into a sheet around a rod-shaped mandrel, applying compressive force around the wrapped membrane while being supported by the mandrel, and then extracting the mandrel from the compressed membrane over-wrap.

The disclosure enables practical implementation of solid-state CO₂ capture technology for industrial and vehicle emissions through a manufacturing approach that overcomes traditional limitations in processing ionic solid membranes.

Accordingly, in one aspect, the disclosure provides an apparatus for capturing carbon dioxide gas, the apparatus comprising: an outer perforated tube; an inner perforated tube; and a solid-state membrane composed of lithium zirconate (LZO) or a compound formulation composed substantially of LZO, wherein the outer perforated tube and the inner perforated tube are configured coaxially, thereby providing an annular space; wherein the LZO solid-state membrane is positioned in the annular space.

In some embodiments, the apparatus further comprises a gaseous mixture comprising carbon dioxide, wherein the LZO solid-state membrane selectively captures carbon dioxide from the gaseous mixture.

In some embodiments, the gaseous mixture has a temperature range of about 500°C to about 900°C.

In some embodiments, the gaseous mixture comprising carbon dioxide enters the apparatus from 1) the inner perforated tube, or 2) from the outer perforated tube and permeates outward through the membrane and outer perforated tube, or inward through the membrane and into the inner perforated tube.

In some embodiments, the outer perforated tube and the inner perforated tube comprise a section on each end that is non-perforated.

In some embodiments, the outer perforated tube and the inner perforated tube are conjoined on each non-perforated end section with reducing fittings or welded end-caps, thereby providing sealing on the ends of the outer perforated tube and the inner perforated tube.

In some embodiments, the outer perforated tube and the inner perforated tube are made from stainless steel, nickel-based superalloy, refractory metal, and/or ceramic materials.

In some embodiments, the outer perforated tube and the inner perforated tube are resistant to corrosion and/or a temperature not less than 500°C.

In some embodiments, the outer perforated tube and the inner perforated tube are perforated by mechanical drilling, wire electric discharge machining (EDM), and/or laser drilling.

In some embodiments, the outer perforated tube and the inner perforated tube are pre-treated at about 650°C for at least 1 hour at a ramp rate of about 5°C/min to remove residual stresses.

In another aspect, the disclosure provides a method of producing an apparatus for capturing carbon dioxide gas, the method comprising: providing an outer perforated tube and an inner perforated tube, wherein the outer perforated tube and the inner perforated tube are configured coaxially to provide an annular space; blocking the perforations of the outer perforated tube and the inner perforated tube; introducing lithium zirconate (LZO) or a compound formulation substantially composed of LZO into the annular space; and compressing the LZO into an LZO solid-state membrane, thereby producing an apparatus in its green state for capturing carbon dioxide gas.

In some embodiments, the method further comprises subjecting the apparatus to a thermal treatment to transform the membrane from its green state to a sintered state of desired property.

In some embodiments of the method, the thermal treatment comprises treating the apparatus at an elevated temperature required for processing refractory ceramics.

In some embodiments, the method further comprises attaching reducing fittings or welded end-caps to the ends of the outer perforated tube and the inner perforated tube.

In some embodiments of the method, the blocking comprises 1) wrapping the outer perforated tube with high-tensile-strength tape, glass fiber, and/or carbon fiber; and/or 2) inserting the apparatus into the internal diameter of a solid plastic, metal, or elastomeric tube, and/or a solid rod with a diameter smaller than that of the inner perforated tube.

In some embodiments of the method, the blocking of the outer perforated tube comprises using an outer axisymmetrically split cylinder conjoined around the outer perforated tube and held in place by various means including, but not limited to, multiple split clamps.

In some embodiments of the method, the LZO is introduced into the annular space in the form of a dry, wet, or semi-wet powder or paste.

In some embodiments of the method, the LZO is incrementally introduced into the annular space and compressed into a solid state to reach a predetermined material property.

In yet another aspect, the disclosure provides a system for producing an apparatus for capturing carbon dioxide gas, the system comprising: a mechanical frame; a load cell; a cylindrical ram; an outer clam shell; an inner support rod; a lower fixture; a hydraulic actuator; and an apparatus comprising an outer perforated tube and an inner perforated tube, wherein the outer perforated tube and the inner perforated tube are configured coaxially to provide an annular space.

In another embodiment, the disclosure provides a two-part compression mold apparatus that is used to form a whole-body, free-standing tubular membrane by enabling a means of applying high compressive loads to the packed membrane material in forming the tubular membrane. The two-part mold may be designed and fabricated to produce any net shape tubular structure, including ones with appendages for flange-type connections that are built into the net shape of the molded membrane structure.

In another embodiment, the disclosure provides a method of forming a whole-body, free standing tubular membrane by first over-wrapping membrane material that was previously rolled or tape casted into a sheet around a rod-shaped mandrel, applying compressive force around the wrapped membrane while being supported by the mandrel, and then extracting the mandrel from the compressed membrane over-wrap. Any means of applying high compressive force around the wrapped membrane and mandrel may be employed in forming the tubular membrane, including, but not limited to, isostatic gas pressure or mechanical compression.

In some embodiments, the system further comprises lithium zirconate (LZO) or a compound formulation substantially composed of LZO, wherein the LZO is introduced into the annular space between the outer perforated tube and the inner perforated tube and compacted into a solid-state membrane.

In some embodiments of the system, the apparatus is subjected to a heat treatment profile.

Unless defined otherwise, the term “about,” particularly in reference to a given quantity, is meant to encompass deviations of plus or minus ten percent.

### BRIEF DESCRIPTION OF THE DRAWINGS

FIG. 1 shows a schematic of an exemplary annular membrane assembly, illustrating the inner and outer perforated tubes, the annulus space containing the membrane material, and the completed assembly.

FIG. 2 shows an engineering drawing of exemplar perforated tubes for manufacturing an annular membrane, including detailed specifications of perforation patterns and dimensions.

FIG. 3 shows an exemplary apparatus for compacting membrane material in the annulus space between perforated tubes, illustrating the mechanical frame, compression system, and support structures.

FIG. 4 shows an exemplary apparatus for compression molding membrane material in annulus space between mold body and an inner support rod.

FIG. 5 shows a previously rolled or tape casted membrane sheet over-wrapped around a mandrel.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

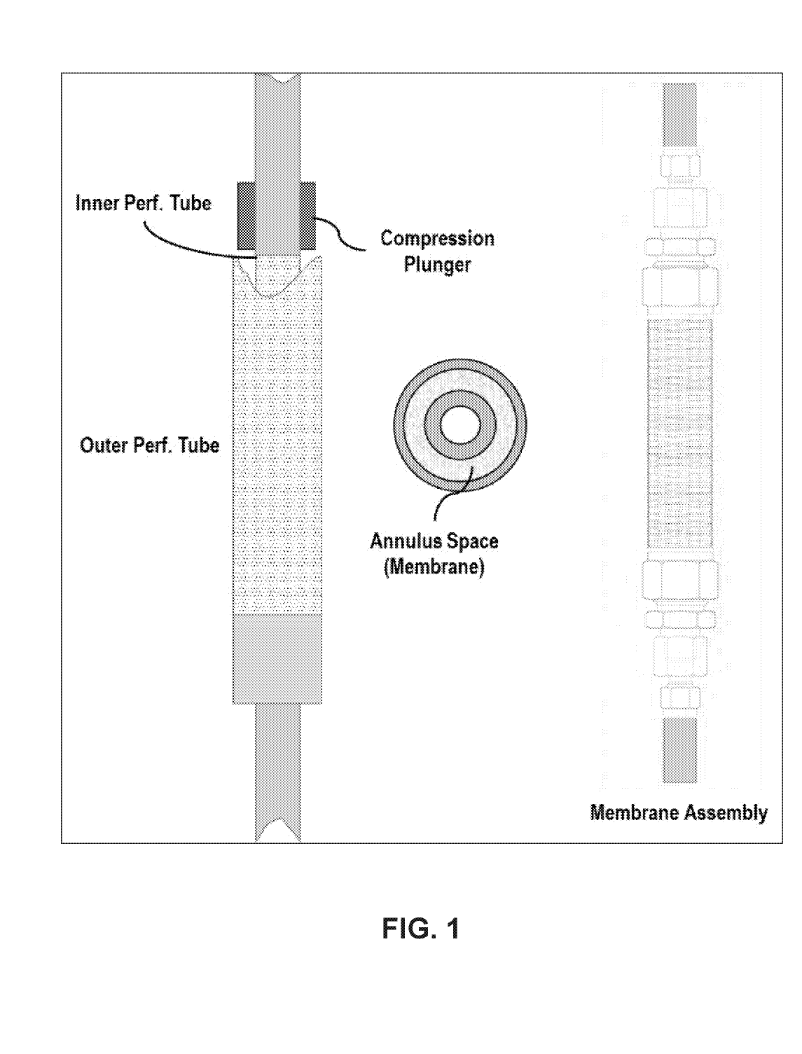

A central construct of the present disclosure comprises a solid membrane formed in place within a tubular annulus space that is confined by perforated tubular structures for gas ingress and permeation through the annular membrane. As illustrated in FIG. 1, the membrane assembly may comprise an outer perforated tube and an inner perforated tube of smaller diameter that are configured coaxially and joined on each end using either appropriately sized reducing fittings or welded end-caps. The fittings or welded end-caps center the inner perforated tube on-axis within the outer perforated tube, providing an annulus space between the walls of the two perforated tubes.

The reducing fittings or welded end-caps further provide gas-tight seals on both perforated tubes to isolate process gas mixtures entering the inner perforated tube from the permeation space surrounding the outer perforated tube. The membrane assembly may be alternatively employed such that process gas mixtures encounter the outer perforated tube and selectively permeate inward into the inner perforated tube. The assembly is designed to operate with gaseous mixtures at temperatures ranging from about 500°C to about 900°C.

The perforated tubes are constructed from materials that are compatible with gaseous effluents and process environments under extreme conditions, including temperatures in excess of 500°C or corrosive environments. Suitable construction materials include austenitic stainless steels, nickel-based superalloys such as Inconel® 625, refractory metals, and ceramics. These materials are selected for their ability to maintain structural integrity and corrosion resistance at elevated temperatures.

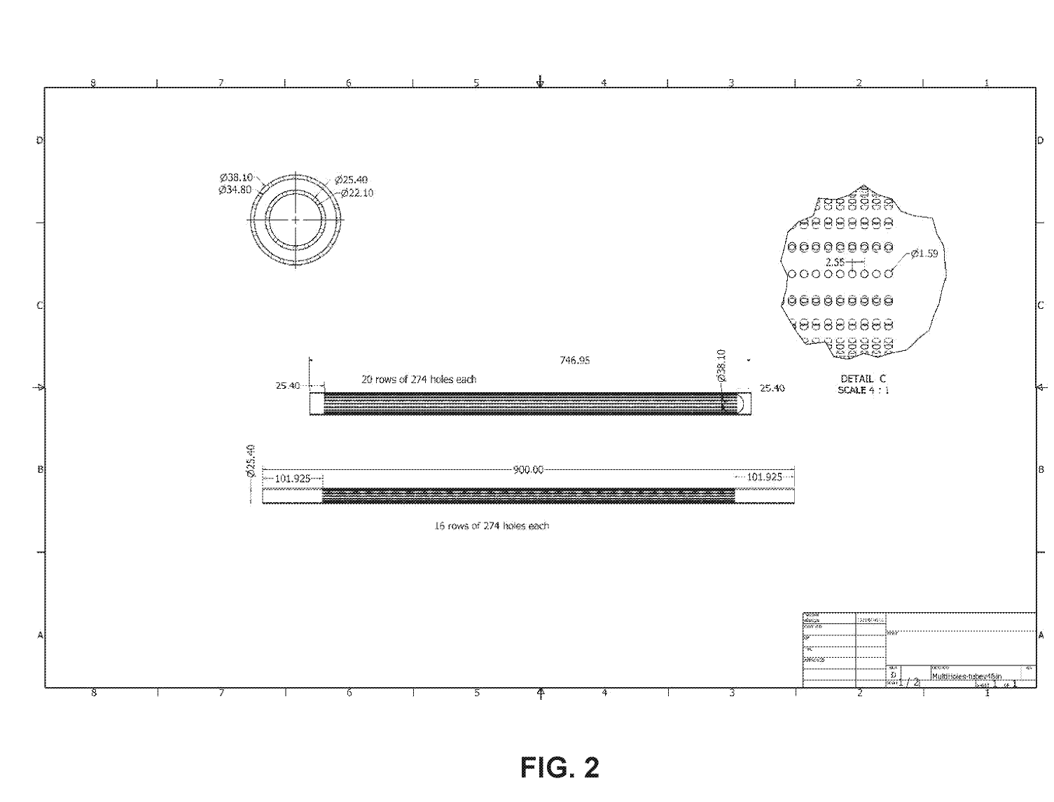

As illustrated in FIG. 2, each perforated tube may include carefully designed perforation patterns. The preferred embodiment employs tubes composed of 316L stainless steel, with small, equally spaced through-wall perforations around the tube's circumference and along a substantial section of its length. Each tube maintains short sections on the ends that are not perforated, providing impermeable barriers beyond the membrane compact that enable sealing of the annulus space.

Various means of machining perforations through the wall of each tube can be employed, including mechanical drilling, wire electric discharge machining (EDM), and laser drilling. Prior to use in the manufacture of an annulus membrane assembly, the perforated tubes undergo heat treatment at 650°C for at least 1 hour at a ramp rate of 5°C/min to remove residual stresses.

The manufacturing process begins with blocking the perforations of each tube through various means. The outer perforated tube may be wrapped with high tensile strength tape, glass fiber, or carbon fiber, while the inner tube perforations may be blocked by inserting into the internal diameter a plastic, metal, or elastomeric tube or solid rod of slightly smaller outer diameter. In the preferred embodiment, an outer axisymmetrically-split cylinder is employed as a clam shell to both block the outer perforations and provide robust structural support for the outer perforated tube to contain the high hoop stresses that arise when compacting the membrane material.

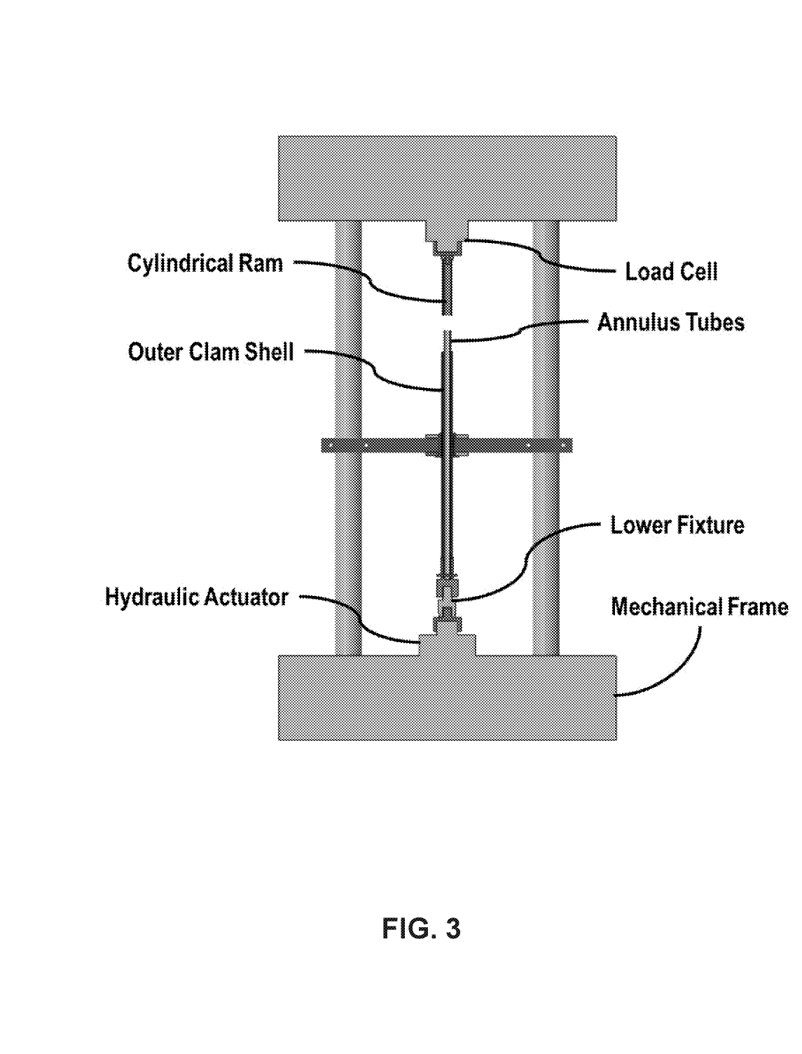

As illustrated in FIG. 3, the compression system may comprise several key components. The annulus assembly is connected to the hydraulic actuator of a mechanical test frame via a lower fixture, while horizontal bending moments are constrained with a crossbeam support at the mid-section. A cylindrical compaction ram, aligned precisely on axis with the annulus assembly, is connected to a load cell supported by the crosshead of the mechanical frame. These components can be moved along the vertical direction as incremental quantities of membrane material are compacted from bottom to top of the annulus assembly.

The annulus space is filled from the top opening with various forms of membrane materials, including dry, wet, or semi-wet powders or pastes. Many different approaches to this step can be employed depending on the physical and chemical characteristics of the membrane material. The preferred procedure involves adding and compacting incremental amounts of membrane material until the desired density is achieved.

After an incremental addition of membrane material, the compaction ram is lowered into the annulus space and the servo-hydraulic actuator is displaced upward under displacement control until the applied load reaches a predetermined value. The ram is then retracted, and this procedure is repeated until the annulus space is completely filled and compacted. For the annulus assembly illustrated in FIG. 2, peak compaction loads of 20,000 lbf (89 kN) are readily achieved without inducing plastic yield on any part of the assembly.

Following the compaction process, the resultant green body state of the membrane material confined within the annulus space can be subjected to a heat treatment profile to transform it to its final dense state. For 316L stainless steel annulus assemblies, heat treatment up to 920°C is acceptable. In cases requiring higher temperatures, the perforated tube assembly may be manufactured from various refractory materials, such as nickel-based superalloys, to enable compatibility with elevated processing temperatures.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

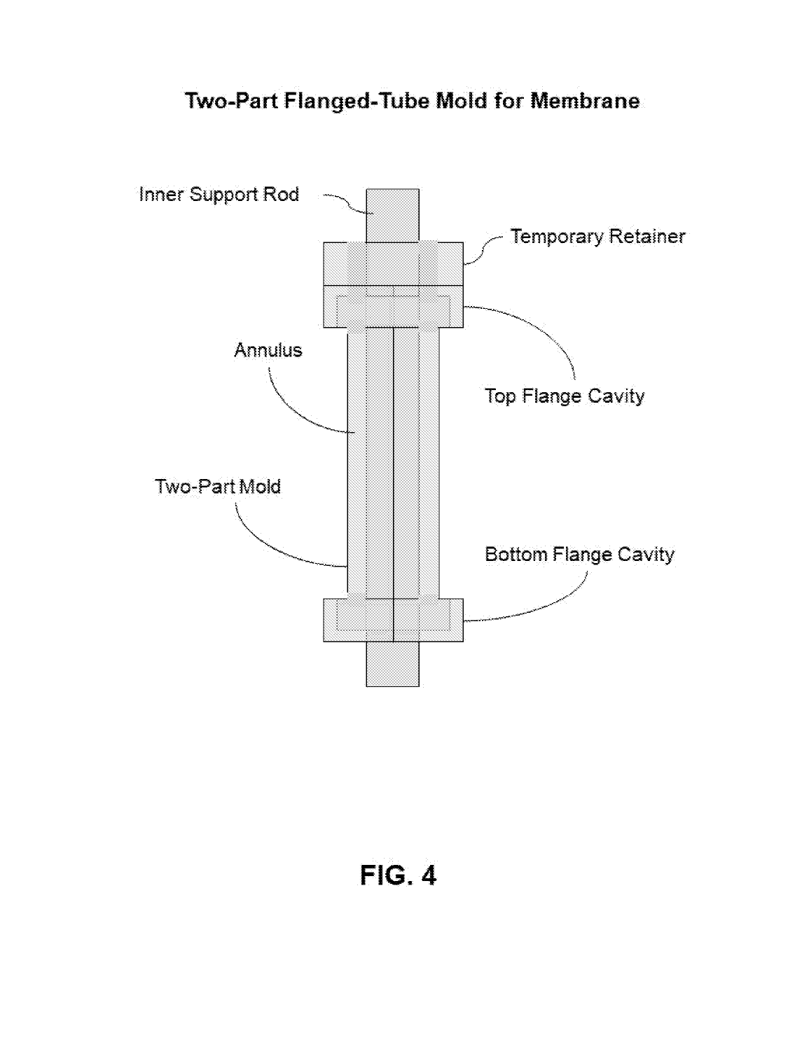

Another construct of the present disclosure entails the fabrication of a two-part compression mold, and example of which is illustrated in FIG. 4. Each half of the mold is an axisymmetric impression of the net shape geometry of a whole-body cylindrical membrane. By taking advantage of the extrusion properties of the membrane formulation, any number of structural features may be included in the net shape of the cylindrical membrane. For example, flange appendages may be incorporated at each end of the cylindrical membrane to enable mechanical coupling of the membrane structure to processes machinery, such as an effluent source containing a mixture of gases.

Similar to the above mentioned annulus embodiment, the two-part mold forms an annulus space between the mold cavities and an inner support rod when assembled. The membrane structure is formed by adding incremental amounts of the membrane formulation as a loose powder or a viscous paste into the annulus space through the top opening of the mold. With each incremental addition, the membrane material is compressed under high compaction loads using the same mechanical frame, compaction ram, and methods as was described above for the annulus embodiment (FIG. 3).

After an incremental addition of membrane material, the compaction ram is lowered into the annulus space of the mold and the servo-hydraulic actuator is displaced upward under displacement control until the applied load reaches a predetermined value. The ram is then retracted, and this procedure is repeated until the annulus space in the mold is completely filled and compacted. For the mold assembly illustrated in FIG. 4, peak compaction loads of 40,000 lbf (178 kN) can be readily achieved depending on the mold wall thicknesses and clamping forces employed in the design.

Following the compaction process, the clamping mechanism for the mold is loosened and the inner support rod is extracted. The mold halves are then split apart and the molded whole-body cylindrical membrane is released from the mold halves. Any number of release agents or mold surface treatments may be employed to facilitate releasing the net shaped membrane from the mold, which are known to those of ordinary skill. For example, boron nitride spray-on surface films, nitriding of mold faces, or deposition of a low surface energy coating such as diamond like carbon (DLC) may be employed alone or in combination with each other.

The resultant green body state of the molded membrane is then subjected to an appropriate heat treatment schedule to transform the membrane to its densified state. In the present whole-body membrane, the highest heat treatment temperature for densification is only constrained by the properties of the membrane material itself and not by any other structural material such as the metallic perforated tubes used in the foregoing annulus embodiment.

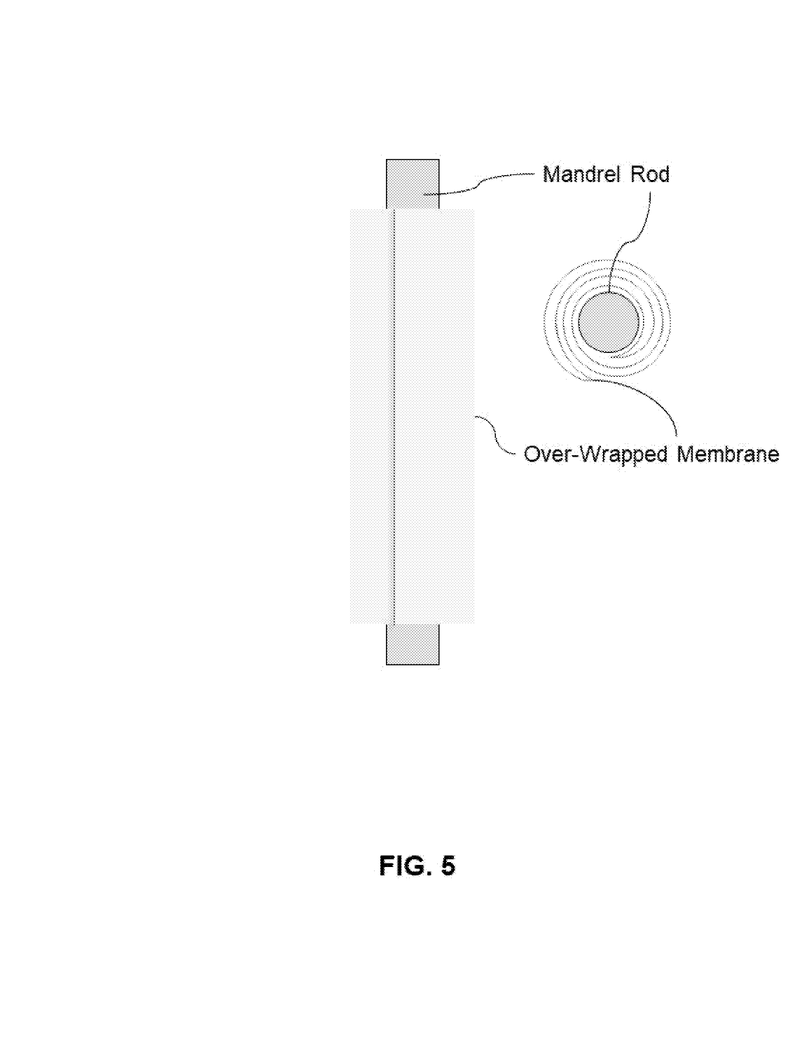

In yet another construct of the present disclosure, the membrane formulation is first rolled or tape casted into a flexible sheet using any number of methods known to those familiar with the art of processing ceramic green bodies. As illustrated in FIG. 5, the resultant sheet is then over-wrapped around a mandrel of arbitrary length and diameter such that the number of over-wrap turns establishes the approximate wall thickness of the cylindrical membrane to be formed.

After forming the membrane-wrapped mandrel to the desired thickness, the membrane over-wrap and mandrel are subjected to compressive force under room temperature using, for example, isostatic gas pressure or direct mechanical pressure via a pressurized bladder around the over-wrapped membrane to densify the membrane over-wrap.

Following the densification step, the mandrel is extracted from the densified membrane over-wrap. As in the previous embodiment, any number of release agents or surface treatments may be employed to facilitate extracting the mandrel from membrane over-wrap, which are known to those of ordinary skill. For example, boron nitride spray-on surface films, nitriding of mandrel surface, or deposition of a low surface energy coating such as diamond like carbon (DLC) may be employed alone or in combination with each other.

The resultant whole-body cylindrical membrane in its green-body state is then subjected to an appropriate heat treatment schedule to transform the membrane to its fully densified state. As in the foregoing embodiment, the highest heat treatment temperature for densification is only constrained by the properties of the membrane material itself and not by any other structural material.

### EXAMPLES

The following examples are offered to illustrate provided embodiments and are not intended to limit the scope of the present disclosure.

### Example 1: Fabrication of Perforated Tube Assembly

A set of perforated tubes is manufactured according to the engineering specifications shown in FIG. 2. The tubes are fabricated from 316L stainless steel using laser drilling to create precisely spaced perforations. The outer tube and inner tube are designed with unperforated sections at each end to facilitate sealing. Following fabrication, the tubes undergo stress relief heat treatment at 650°C for 1 hour using a 5°C/min ramp rate.

The tubes are then assembled coaxially using welded end-caps to maintain precise alignment and create the desired annular space. Pressure testing confirms the gas-tight seal at the end-caps while maintaining open perforations along the active membrane section.

### Example 2: Membrane Material Compaction Process

A complete membrane assembly is prepared using the system shown in FIG. 3. The outer tube perforations are blocked using a split clam shell design, while a solid rod is inserted into the inner tube to prevent material intrusion during compaction. LZO powder is introduced incrementally into the annular space, with each layer subjected to controlled compression.

The servo-hydraulic system applies compressive loads up to 89 kN while maintaining precise alignment through the support fixtures. Load cell measurements confirm uniform compression throughout the membrane volume. The incremental filling and compression process continues until the entire annular space is filled with compacted membrane material.

### Example 3: Heat Treatment and Performance Verification

The completed assembly from Example 2 undergoes thermal processing to transform the green body membrane into its final state. The assembly is heated to 920°C under controlled conditions appropriate for the 316L stainless steel construction. Following heat treatment, the membrane assembly is tested with a CO₂-containing gas mixture at 500-700°C to verify selective permeation performance.

Gas flow testing confirms proper flow patterns through both the inner and outer perforated tubes, with successful selective capture of CO₂ from the gas mixture. The membrane maintains structural integrity throughout thermal cycling, demonstrating the effectiveness of the manufacturing process in creating a robust separation device.

### Example 4: Two-Part Compression Mold Fabrication and Use

A two-part compression mold is fabricated according to the design shown in FIG. 4. The mold is machined from heat-treated tool steel with axisymmetric cavities forming a net-shape tubular membrane with integral flange appendages. The mold surfaces are implanted with nitrogen atoms (i.e., nitriding) and coated with DLC, then treated with a boron nitride release coating.

The mold is assembled with an inner support rod defining an annulus space. LZO powder is incrementally added through the top opening and compressed using the disclosed apparatus, achieving compaction loads of 133 kN. After filling, the inner rod is extracted and mold halves separated to release the green-body membrane.

The molded membrane, including integral flanges, maintains dimensional stability and shows no defects. The membrane is successfully heat treated to achieve full densification at temperatures exceeding 1000°C, demonstrating the advantage of unconstrained thermal processing compared to the perforated tube embodiment.

### Example 5: Overwrapped Membrane Formation

A flexible LZO membrane sheet is formed by tape casting to a thickness of 3.25 mm. As shown in FIG. 5, the sheet is wrapped around a mandrel treated with diamond-like carbon release coating, creating 2 overwrap layers to achieve a 6.4 mm wall thickness.

The wrapped assembly is placed in an isostatic press and subjected to 138 MPa pressure at room temperature. After compression, the mandrel is successfully extracted leaving a uniform tubular membrane. The membrane is heat treated following the same profile as Example 4, achieving comparable densification and mechanical properties.

The overwrap method demonstrates excellent layer consolidation and uniform wall thickness, while allowing unconstrained thermal processing similar to the compression molded embodiment.

Taken together, these examples demonstrate successful implementation of using the disclosed methods for manufacturing annular membrane assemblies for CO₂ capture applications. The examples illustrate key aspects of the disclosure, from the initial fabrication of precisely perforated tubular components, through the controlled compaction of LZO membrane material in the annular space, to the final heat treatment and performance verification of the completed assembly. The results show effective formation of a structurally robust annular membrane system capable of selective CO₂ capture at elevated temperatures, demonstrating the practical viability of the manufacturing approach for creating high-performance gas separation devices for various industrial and vehicular applications.

What is claimed is:

1. An apparatus for capturing carbon dioxide gas, the apparatus comprising:
an outer perforated tube;
an inner perforated tube; and
a solid-state membrane composed of lithium zirconate (LZO) or a compound formulation composed substantially of LZO,
wherein the outer perforated tube and the inner perforated tube are configured coaxially, thereby providing an annular space;
wherein the LZO solid-state membrane is positioned in the annular space.

2. The apparatus of claim 1, further comprising a gaseous mixture comprising carbon dioxide, wherein the LZO solid-state membrane selectively captures carbon dioxide from the gaseous mixture.

3. The apparatus of claim 2, wherein the gaseous mixture has a temperature range of about 500°C to about 900°C.

4. The apparatus of claim 2, wherein the gaseous mixture comprising carbon dioxide enters the apparatus from 1) the inner perforated tube, or 2) from the outer perforated tube and permeates outward through the membrane and outer perforated tube, or inward through the membrane and into the inner perforated tube.

5. The apparatus of claim 1, wherein the outer perforated tube and the inner perforated tube comprise a section on each end that is non-perforated.

6. The apparatus of claim 5, wherein the outer perforated tube and the inner perforated tube are conjoined on each non-perforated end section with reducing fittings or welded end-caps, thereby providing sealing on the ends of the outer perforated tube and the inner perforated tube.

7. The apparatus of claim 1, wherein the outer perforated tube and the inner perforated tube are made from stainless steel, nickel-based superalloy, refractory metal, and/or ceramic materials.

8. The apparatus of claim 1, wherein the outer perforated tube and the inner perforated tube are resistant to corrosion and/or a temperature not less than 500°C.

9. The apparatus of claim 1, wherein the outer perforated tube and the inner perforated tube are perforated by mechanical drilling, wire electric discharge machining (EDM), and/or laser drilling.

10. The apparatus of claim 1, wherein the outer perforated tube and the inner perforated tube are pre-treated at about 650°C for at least 1 hour at a ramp rate of about 5°C/min to remove residual stresses.

11. A method of producing an apparatus for capturing carbon dioxide gas, the method comprising:
providing an outer perforated tube and an inner perforated tube, wherein the outer perforated tube and the inner perforated tube are configured coaxially to provide an annular space;
blocking the perforations of the outer perforated tube and the inner perforated tube;
introducing lithium zirconate (LZO) or a compound formulation substantially composed of LZO into the annular space; and
compressing the LZO into an LZO solid-state membrane, thereby producing an apparatus in its green state for capturing carbon dioxide gas.

12. The method of claim 11, further comprising subjecting the apparatus to a thermal treatment to transform the membrane from its green state to a sintered state of desired property.

13. The method of claim 12, wherein the thermal treatment comprises treating the apparatus at an elevated temperature required for processing refractory ceramics.

14. The method of claim 11, further comprising attaching reducing fittings or welded end-caps to the ends of the outer perforated tube and the inner perforated tube.

15. The method of claim 11, wherein the blocking comprises 1) wrapping the outer perforated tube with high-tensile-strength tape, glass fiber, and/or carbon fiber; and/or 2) inserting the apparatus into the internal diameter of a solid plastic, metal, or elastomeric tube, and/or a solid rod with a diameter smaller than that of the inner perforated tube.

16. The method of claim 11, wherein the blocking of the outer perforated tube comprises using an outer axisymmetrically split cylinder conjoined around the outer perforated tube and held in place by various means including, but not limited to, multiple split clamps.

17. The method of claim 11, wherein the LZO is introduced into the annular space in the form of a dry, wet, or semi-wet powder or paste.

18. The method of claim 11, wherein the LZO is incrementally introduced into the annular space and compressed into a solid state to reach a predetermined material property.

19. A system for producing an apparatus for capturing carbon dioxide gas, the system comprising:
a mechanical frame;
a load cell;
a cylindrical ram;
an outer clam shell;
an inner support rod;
a lower fixture;
a hydraulic actuator; and
an apparatus comprising an outer perforated tube and an inner perforated tube,
wherein the outer perforated tube and the inner perforated tube are configured coaxially to provide an annular space.

20. The system of claim 19, further comprising lithium zirconate (LZO) or a compound formulation substantially composed of LZO, wherein the LZO is introduced into the annular space between the outer perforated tube and the inner perforated tube and compacted into a solid-state membrane.

21. The system of claim 19, wherein the apparatus is subjected to a heat treatment profile.

22. An apparatus for forming a whole-body tubular membrane, the apparatus comprising:
a two-part compression mold having axisymmetric impressions forming a net shape geometry of a cylindrical membrane when assembled;
an inner support rod positioned within the two-part compression mold;
flange appendages incorporated at each end of the cylindrical membrane geometry; and
wherein the two-part compression mold and inner support rod define an annulus space for receiving membrane material.

23. The apparatus of claim 22, wherein the flange appendages are configured for mechanical coupling to process machinery.

24. The apparatus of claim 22, further comprising a release coating on interior surfaces of the two-part compression mold.

25. The apparatus of claim 24, wherein the release coating comprises at least one of: boron nitride, nitriding treatment, or diamond-like carbon coating.

26. A method of forming a whole-body tubular membrane, the method comprising:
forming a flexible membrane sheet by rolling or tape casting membrane material;
wrapping the flexible membrane sheet around a mandrel to form multiple overwrap turns establishing a desired wall thickness;
applying compressive force around the wrapped membrane while supported by the mandrel; and
extracting the mandrel from the compressed membrane overwrap.

27. The method of claim 26, wherein applying compressive force comprises at least one of:
applying isostatic gas pressure; and
applying direct mechanical pressure via a pressurized bladder.

28. The method of claim 26, further comprising applying a release coating to the mandrel prior to wrapping the membrane sheet.
